(19) United States
(12) Patent Application Publication
(10) Pub. No.: US 2024/0354280 A1
(43) Pub. Date: Oct. 24, 2024

(54) COMPUTING ARRAY USING GLOBAL NODE PROCESSING

(71) Applicant: International Microsystems Inc., Fremont, CA (US)

(72) Inventor: Peter Arthur Schade, Fremont, CA (US)

(21) Appl. No.: 18/639,452

(22) Filed: Apr. 18, 2024

Related U.S. Application Data
(60) Provisional application No. 63/496,826, filed on Apr. 18, 2023.

(51) Int. Cl. G06F 15/80

(52) U.S. Cl. CPC G06F 15/80

(57) ABSTRACT

The present invention describes a parallel computer consisting of a manager connected to an array of computing nodes wherein each node has associated data storage and processing capability. In addition means are provided that either allow any node data access to its adjacent nodes or allow all nodes to randomly access all the storage at every node. The present invention is particularly suitable for artificial intelligence machine learning computing where multiple processors require large and fast access to large data sets.

### FIELD OF INVENTION

The present invention relates to the design of parallel computer that is capable of holding a large data set that can be stored and analyzed in a very fast and efficient manner and is suitable for use in processing large data sets for many High Performance Computing (“HPC”) tasks such as used in artificial intelligence (or “AI”) machine learning applications. The HPC computer presented in this patent is especially suited for use in a 1 U (i.e., a 1.75 in high) 19″ rack mountable server case although other sizes can be used. We refer to the invention as a “Global Array Processor” or “GAP” computer. The GAP design is a modified version of an earlier patent by Schade (“U.S. Pat. No. 11,016,927B2”) which defined a “Disjoint Array Computer” or “DAC” and which is herein incorporated by reference.

### BACKGROUND

AI machine learning is becoming a widely used method of increasing the productivity of many human endeavors. Because the necessary computer analysis must include many examples of the process to be optimized, the size of the machine learning data sets can be very large, sometimes in the petabyte range. Because of this, the actual number of computer processors processing the data must be large so that the time taken to process typical machine learning data sets is acceptable. In addition, ta common requirement for AI machine learning is that every processor used in a given analysis must analyze the whole data set.

The two requirements of a large data set and a large number of processors to analyze the entire data set is a major challenge facing the design of a machine learning HPC computer. A typical HPC example is seen in FIG. 1 where multiple processors are connected using a serial interface such as Ethernet which in turn is connected to a large AI data set such as an Ethernet NAS storage device and a AI manager which controls the AI processors and communicates with the user. The problem with the solution shown in FIG. 1 is that complete access to a large data set by many different processors can be too slow for the desired processing rate due to data access significant contention between processors and a single shared data channel. What is needed is a computer architecture for today's AI machine learning tasks that provides high speed computation using a large number of processors packaged in standard minimal height server with a reasonable total cost of ownership.

### SUMMARY OF THE INVENTION

The invention describes a novel way to build an HPC computer suited for software tasks requiring fast processing of large data sets such as AI machine learning applications.

In one embodiment, the GAP computer is a parallel computer which includes a large user data storage distributed over an array of nodes each with a user storage element; the sum of which constitutes the GAP user storage area. Each GAP node is connected to a central manager called the GAP Manager such that the GAP Manager shares read/write access to all node user storage.

The DAC architecture in U.S. Pat. No. 11,001,6927B2 patent uses disjoint nodes which cannot directly access each other data storage. DAC works for data bases that can be processed in a distributed manner without the requirement that the nodes are able to access each other's data storage. However for the GAP server described herein, to satisfy the machine learning requirement that each processing element has access to the entire user data storage, the GAP nodes can no longer be disjoint. Thus in contrast to the DAC architecture, the GAP server described herein includes various embodiments for the nodes that interact with each other so that each node may have access to all the node storage data either sequentially or randomly.

### BRIEF DESCRIPTION OF THE DRAWINGS

FIG. 1 illustrates an example Ethernet Connect Machine Learning Server.

FIG. 2 illustrates an example GAP Machine Learning Server.

FIG. 3 illustrates an example GAP Node with attached AI Processors.

FIG. 4 illustrates an example GAP Adjacent Node Data Transfer.

FIG. 5 illustrates an example GAP Backplane Node to Node Cross Point Transfer.

FIG. 6 illustrates an example GAP Process Level Diagram.

### DETAILED DESCRIPTION OF THE INVENTION

This invention describes a network topology we call GAP which is a modified version of a patent by Schade “U.S. Pat. No. 11,001,6927B2”. A GAP computer is a parallel computer which includes a large user data storage distributed over an array of processing nodes each with a user storage element wherein the sum of all the node user storage constitutes the user storage area. In addition, each GAP node is connected to a central manager called the GAP Manager such that the GAP Manager shares read/write access to the all the node user storage.

A concept that is helpful to understand the GAP is that of the “user storage segment”. The user storage segment is that amount of user storage that is typically processed at one time by one processor. In the GAP computer, each GAP node may hold one or more user storage segments the sum of which constitutes the node user storage element.

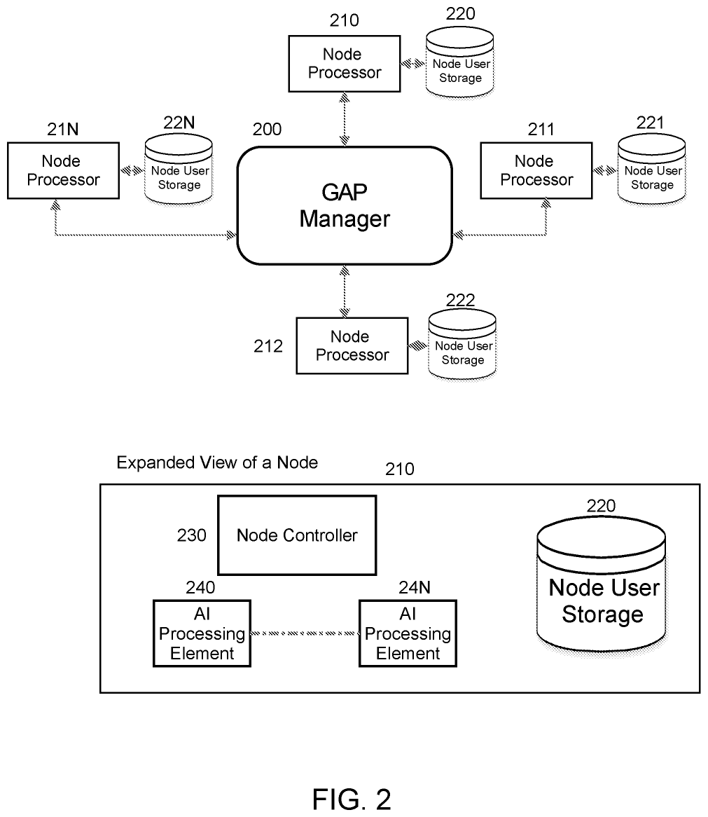

Because the GAP may have a lot of nodes, each with a node controller that either internally or externally controls many processors for the node user storage analysis, it is also helpful to use the nomenclature GAP-Nxx where GAP-N00 is the zeroth node. The GAP-N nodes provide the desired software and hardware to analyze the user data segments associated with the node. In one embodiment shown in FIG. 2, the GAP-N nodes 210-21N are connected to the GAP Manager 200, the user node data storage 220 to 22N are respectively attached to nodes 210-21N along with associated GAP node controllers 230-23N and the node processing elements 240-24N which in this embodiment are internally included in the GAP-N controllers 230-23N.

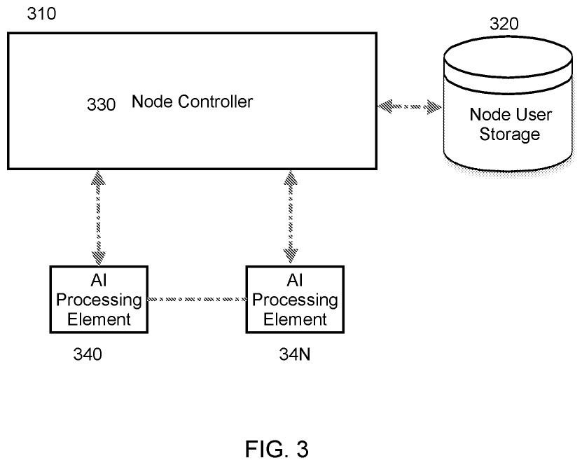

In a second embodiment shown in FIG. 3, the GAP node is similar to that shown in FIG. 2 with exception that the node user storage processing elements, 311 to 31N, are externally connected devices which we denote as GAP-N-Pxx.

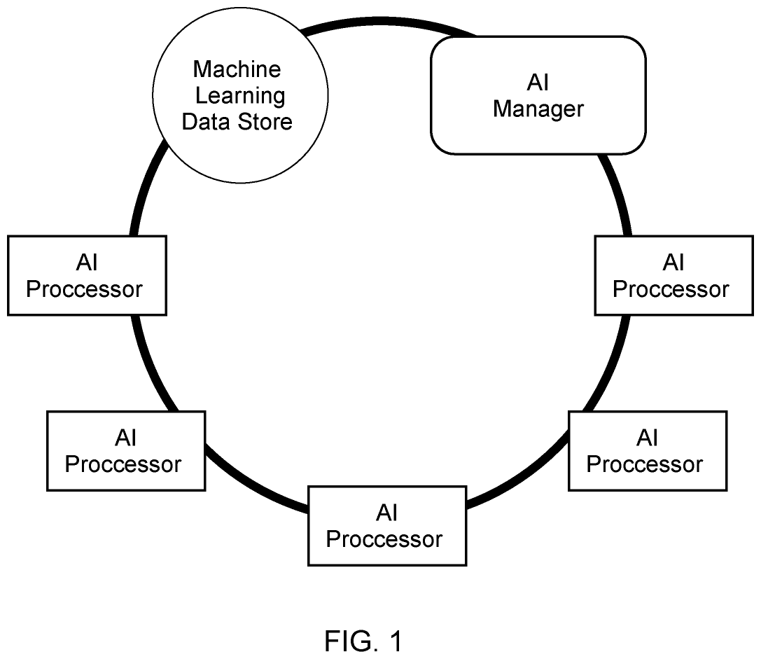

As shown in FIGS. 2 and 3, the GAP-N-P processors are provided with the node user data by their attached GAP-N node processor and do not directly access the node data storage. This greatly simplifies the design of the GAP server and avoids a high rate of contention between machine learning processors for the user storage data as shown in in FIG. 1.

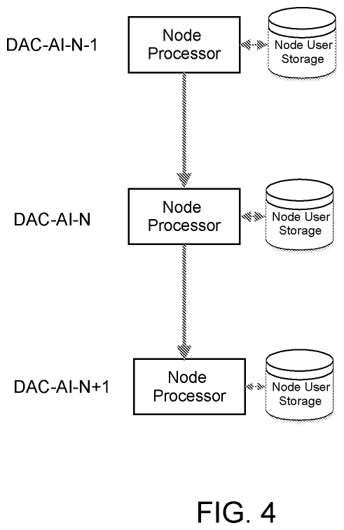

We now describe the enhancement to FIGS. 2 and 3 shown which allows every node access to all the node storage data without the data being transferred by the GAP Master. Using simple circuitry which includes a data multiplexer and command channel, the GAP Node Backplane in FIG. 4 allows the GAP Nth node (GAP-N) using to receive data from an adjacent node, GAP-N−1, that has finished processing a block of the user data storage segments while also allowing the GAP-N node to send similar blocks of data that it has finished processing to adjacent node GAP-N+1. When this circuitry is replicated for all GAP nodes, a complete circular transmission of all node storage data can be easily accomplished. Note that the GAP Manager is not in the data path for the movement of the data from one GAP node to the next although it may be used to control the data transfers.

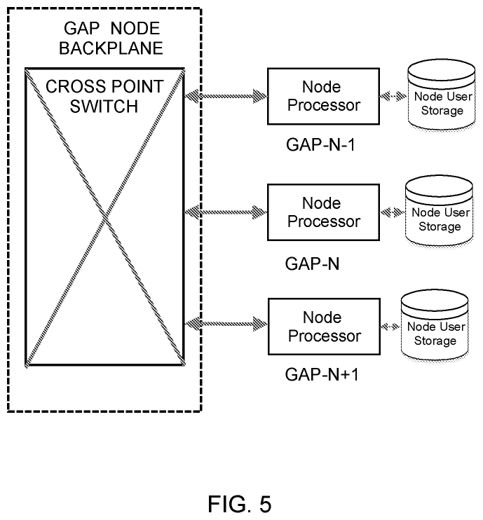

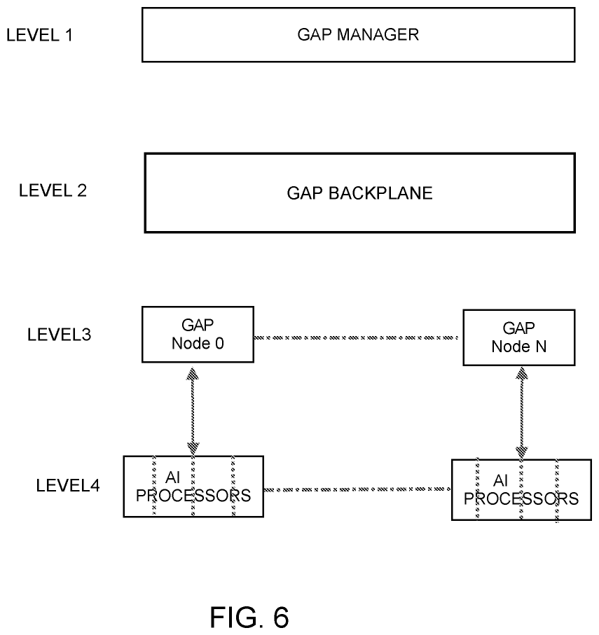

Another embodiment is shown in FIG. 5 provides a node cross point switch on the Node Backplane. Using the node connected cross point switch, any node can access all other node storage data while still being connected to the GAP manager. The control of the cross point switch can either be done by the GAP Manager or by a separate cross point controller added to the GAP node backplane shown in FIG. 6.

The previous paragraphs describe the various hardware elements of the GAP server. For the purposes of describing a sample of the software processing in a GAP server, it is helpful to view the GAP as a 4 level machine as shown in FIG. 6 and summarized below.

Level 1 of the GAP is the GAP Manager which provides a destination for the total user storage data associated with a specific GAP job. The GAP Manager distributes the user job data to all the GAP nodes. In addition the GAP Manager may coordinate the node activity and act as server for the output of the GAP node processing results.

Level 2 of the GAP is the GAP node Backplane which serves as the interface between the GAP Manager and the GAP-N nodes. As described above, the GAP Node Backplane contains circuitry that allows the GAP nodes to share the user data storage.

Level 3 of the GAP is the array of GAP-N nodes which hold a multiple segments of the user storage data to be analyzed by the GAP-N-P processors, which may be included in the GAP-N node controller or physically attached to each of the GAP-N node controller. In addition, the GAP-N nodes may have a data path connection to adjacent nodes or even possibly all the nodes using a Node Backplane depending upon the chosen embodiment.

Level 4 of the GAP are the array of GAP-N-P processors associated with each GAP-N node each with its own local storage capable of holding a minimum of one user storage data segment.

The four level GAP server described above can be made with various elements depending upon the desired speed and complexity is desired. We now describe a possible example of the data flow using the GAP four level groups described above to the GAP server network topology in FIG. 2. We assume for this example that the GAP computer is analyzing a AI machine learning data set.

Step 1: The user data set to be analyzed is first sent to the GAP Manager 200 which distributes workable size data segments to the GAP-N nodes 210-21N.

Step 2: When a given node, GAP-N, determines that all its attached AI data processors have completed processing a segment of its user storage data, it notifies its adjacent forward node, GAP-N+1, that a block of data is available.

Step 3: The GAP=N+1 node receives the new block of user data and adds it to its data que for processing by its attached AI processors.

Step 4. The process described in Step 2 and Step 3 loops until all the data has been processed by all the AI processors in all the nodes.

The above software steps may be modified to enhance the speed or efficiency of the GAP server depending upon the abilities built into the GAP-N nodes and the Node Backplane. An example of such an enhancement is the use of a node cross point switch on the Node Backplane which has been described earlier. However, the distributed nature GAP data set and the simultaneous processing over parallel entities such as the GAP-N nodes is a key attribute of the GAP server.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A parallel computer comprising:
a manager; and
an array of attached computing nodes,
wherein each computing node has associated user storage that is accessible by both the computing node and the manager;
wherein each computing node is configured to share its user storage with all other computing nodes; and
wherein each computing node includes processing for its attached storage.

2. The parallel computer of claim 1, wherein the manager is configured to communicate to all of the computing nodes such that the manager controls the flow of node storage data between the computing nodes.

3. The parallel computer of claim 1, wherein super speed type 3 and type 4 USB gadget connections are used between the manager and the computing nodes.

4. The parallel computer of claim 1, further comprising a controller existing on an internal backplane of the parallel computer that connects to the array of attached computing nodes such that the controller provides means for all computing nodes to have read access to storage data on any computing node.

5. The parallel computer of claim 1 which provides means for all the nodes to swap their data with any other node using a cross point switch connected to each node.

6. The parallel computer of claim 4, wherein super speed type 3 and type 4 USB connections are used between the cross point connected nodes.

7. The parallel computer of claim 4, wherein PCIE connections are used between the cross point connected nodes.

8. The parallel computer of claim 1 that allows every node in a 2-D array of computing nodes to read data from an adjacent lower number node storage and write data to an adjacent higher number node storage with the uppermost node writing data to the lowest numbered node.

9. The parallel computer of claim 1, wherein M.2 NVME SSD storage is used for the node storage.

10. The parallel computer of claim 1, wherein the node processing of its attached storage data is provided by physically distinct processors that are connected to the node.

11. The parallel computer of claim 4, wherein a packet switching node cross point switch is used on the backplane.
